(19) United States
(12) Patent Application Publication
(10) Pub. No.: US 2015/0362630 A1
(43) Pub. Date: Dec. 17, 2015

(54) OPTICAL ELEMENT, HYBRID OPTICAL ELEMENT, INTERCHANGEABLE LENS AND IMAGING DEVICE

(71) Applicant: Panasonic Intellectual Property Management Co., Ltd., Osaka (JP)

(72) Inventor: Jumpei SASAKI, Kanagawa (JP)

(21) Appl. No.: 14/832,299

(22) Filed: Aug. 21, 2015

Related U.S. Application Data
(63) Continuation of application No. PCT/JP2014/000972, filed on Feb. 25, 2014.

(30) Foreign Application Priority Data
Feb. 25, 2013 (JP) 2013-034677

(51) Int. Cl. G02B 1/04; G02B 7/14

(52) U.S. Cl. CPC G02B 1/041; G02B 7/14

(57) ABSTRACT

An optical element is formed of a composite material comprising a resin material and inorganic fine particles dispersed in the resin material. The resin material is composed of a first resin material comprising a compound having fluorine atom in its molecular structure, and a second resin material comprising a compound having carbonyl group and nitrogen atom in its molecular structure. A hybrid optical element includes a first optical element serving as a base material, and a second optical element layered on an optical surface of the first optical element. The second optical element is the above-mentioned optical element.

### CROSS-REFERENCE TO RELATED APPLICATION

This application is a Continuation of International Application No. PCT/JP2014/000972, filed on Feb. 25, 2014, which in turn claims the benefit of Japanese Application No. 2013-034677, filed on Feb. 25, 2013, the disclosures of which Applications are incorporated by reference herein.

### BACKGROUND

1. Field

The present disclosure relates to optical elements, hybrid optical elements, interchangeable lenses and imaging devices.

2. Description of the Related Art

Optical materials in which inorganic fine particles are dispersed in a matrix material such as a resin to increase the range of their optical properties have been known (hereinafter, optical materials having such a structure are also referred to as “composite materials”). Techniques for achieving desired anomalous dispersion property by using such composite materials have been known.

Japanese Laid-Open Patent Publication No. 2011-053518 discloses: a material composition including a carbazole polymerizable compound, a polymerizable compound having 1 to 3 polymerizable functional groups per molecule, inorganic oxide particles, and a polymerization initiator; and an optical element using the material composition.

### SUMMARY

The present disclosure provides an optical element having desired light transmittance and desired anomalous dispersion property. Further, the present disclosure provides a hybrid optical element including the optical element, and an interchangeable lens and an imaging device each including the optical element or the hybrid optical element.

The novel concepts disclosed herein were achieved in order to solve the foregoing problems in the related art, and herein is disclosed:

an optical element formed of a composite material comprising a resin material and inorganic fine particles dispersed in the resin material, wherein

the resin material is composed of a first resin material comprising a compound having fluorine atom in its molecular structure, and a second resin material comprising a compound having carbonyl group and nitrogen atom in its molecular structure.

The novel concepts disclosed herein were achieved in order to solve the foregoing problems in the related art, and herein is disclosed:

a hybrid optical element comprising a first optical element serving as a base material, and a second optical element layered on an optical surface of the first optical element, wherein

the second optical element is an optical element formed of a composite material including a resin material and inorganic fine particles dispersed in the resin material, wherein

the resin material is composed of a first resin material comprising a compound having fluorine atom in its molecular structure, and a second resin material comprising a compound having carbonyl group and nitrogen atom in its molecular structure.

The novel concepts disclosed herein were achieved in order to solve the foregoing problems in the related art, and herein is disclosed:

an interchangeable lens being attachable to and detachable from an imaging device, and comprising an optical element,

the optical element formed of a composite material including a resin material and inorganic fine particles dispersed in the resin material, wherein

the resin material is composed of a first resin material comprising a compound having fluorine atom in its molecular structure, and a second resin material comprising a compound having carbonyl group and nitrogen atom in its molecular structure.

The novel concepts disclosed herein were achieved in order to solve the foregoing problems in the related art, and herein is disclosed:

an interchangeable lens being attachable to and detachable from an imaging device, and comprising a hybrid optical element,

the hybrid optical element comprising a first optical element serving as a base material, and a second optical element layered on an optical surface of the first optical element, wherein

the second optical element is an optical element formed of a composite material including a resin material and inorganic fine particles dispersed in the resin material, wherein

the resin material is composed of a first resin material comprising a compound having fluorine atom in its molecular structure, and a second resin material comprising a compound having carbonyl group and nitrogen atom in its molecular structure.

The novel concepts disclosed herein were achieved in order to solve the foregoing problems in the related art, and herein is disclosed:

an imaging device comprising an optical element,

the optical element formed of a composite material including a resin material and inorganic fine particles dispersed in the resin material, wherein

the resin material is composed of a first resin material comprising a compound having fluorine atom in its molecular structure, and a second resin material comprising a compound having carbonyl group and nitrogen atom in its molecular structure.

The novel concepts disclosed herein were achieved in order to solve the foregoing problems in the related art, and herein is disclosed:

an imaging device comprising a hybrid optical element,

the hybrid optical element comprising a first optical element serving as a base material, and a second optical element layered on an optical surface of the first optical element, wherein

the second optical element is an optical element formed of a composite material including a resin material and inorganic fine particles dispersed in the resin material, wherein

the resin material is composed of a first resin material comprising a compound having fluorine atom in its molecular structure, and a second resin material comprising a compound having carbonyl group and nitrogen atom in its molecular structure.

The optical element and the hybrid optical element according to the present disclosure have desired light transmittances and desired anomalous dispersion properties.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a schematic structural diagram showing a lens according to Embodiment 1, which is an example of an optical element;

FIG. 2 is a schematic diagram showing a composite material of the lens according to Embodiment 1;

FIG. 3 is a schematic structural diagram showing a hybrid lens according to Embodiment 2, which is an example of a hybrid optical element;

FIG. 4 is a schematic diagram explaining a production process of the hybrid lens according to Embodiment 2; and

FIG. 5 is a schematic structural diagram showing an interchangeable lens and an imaging device according to Embodiment 3.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicant provides the attached drawings and the following description so that those skilled in the art can fully understand this disclosure. Therefore, the drawings and description are not intended to limit the subject defined by the claims.

### Embodiment 1

Hereinafter, Embodiment 1 is described with reference to the drawings.

[1. Lens]

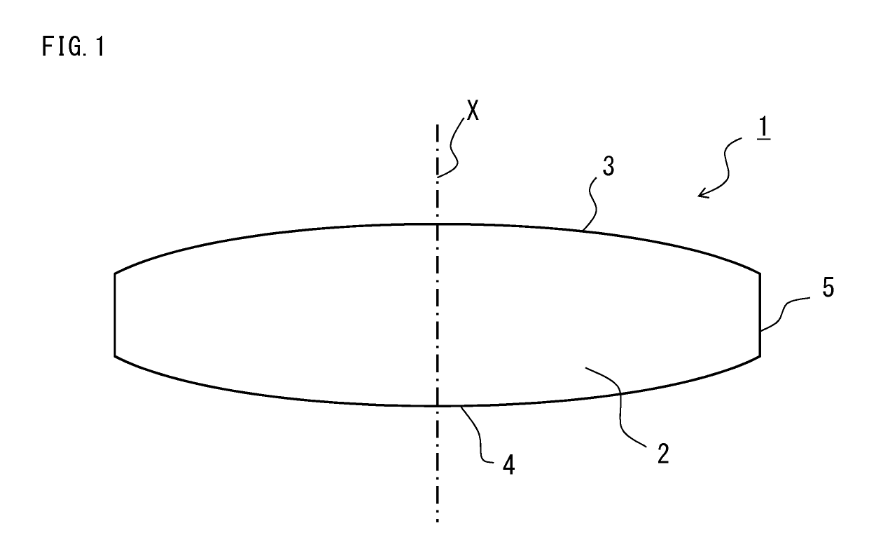

FIG. 1 is a schematic structural diagram showing a lens according to Embodiment 1. The lens 1 is a disc-shaped member composed of an optical portion 2. The lens 1 is a bi-convex lens, and an example of an optical element.

The lens 1 includes a first optical surface 3, a second optical surface 4, and an outer circumferential surface 5. The first optical surface 3 and the second optical surface 4 are opposed to each other in the direction of an optical axis X.

The outer circumferential surface 5 is a surface connecting the edges of the first optical surface 3 to the edges of the second optical surface 4. The outer circumferential surface 5 is the side surface of the lens 1. The outer diameter of the lens 1 is defined by the outer circumferential surface 5. The outer diameter of the optical element in the present disclosure is not particularly limited. In Embodiment 1, the outer diameter ranges from 10 mm to 100 mm, for example.

[2. Composite Material]

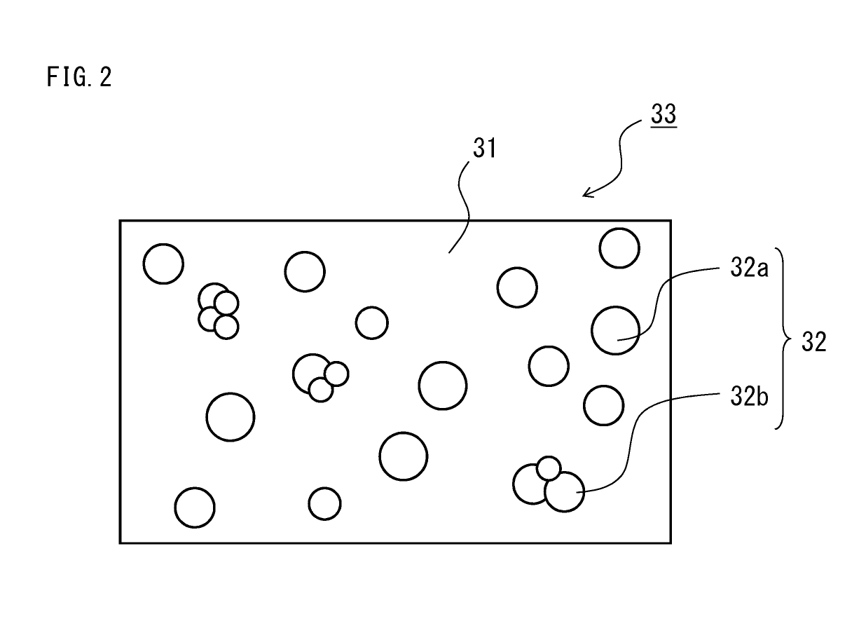

FIG. 2 is a schematic diagram showing a composite material of the lens according to Embodiment 1. FIG. 2 is used for explaining the lens 1 in detail.

As shown in FIG. 2, the lens 1 is formed of a composite material 33. The composite material 33 is composed of a resin material 31 serving as a matrix material, and inorganic fine particles 32.

[3. Inorganic Fine Particles]

The refractive index of the inorganic fine particles 32 varies from material to material. Therefore, the inorganic fine particles 32 may have a higher refractive index or a lower refractive index than the resin material 31. The material used may be selected as appropriate depending on the optical properties required for the lens 1. However, it is beneficial to use, as the inorganic fine particles 32, a material having a higher refractive index than the resin material 31. By appropriately adjusting the kinds, particle diameter, and content of the inorganic fine particles 32, it is possible to adjust the refractive index of the lens 1 formed of the composite material 33 in which the inorganic fine particles 32 are dispersed in the resin material 31.

Examples of the material of the inorganic fine particles 32 include oxides. Examples of the oxides include silicon oxide, zirconium oxide, titanium oxide, zinc oxide, aluminum oxide, yttrium oxide, tin oxide, cerium oxide, niobium oxide, tantalum oxide, europium oxide, gadolinium oxide, magnesium oxide, tungsten oxide, hafnium oxide, indium oxide, potassium oxide, calcium oxide, lanthanum oxide, barium oxide, strontium oxide, nickel oxide, chromium oxide, cadmium oxide, vanadium oxide, praseodymium oxide, neodymium oxide, samarium oxide, terbium oxide, thulium oxide, erbium oxide, dysprosium oxide, holmium oxide, barium titanate, barium sulfate, lithium niobate, potassium niobate, lithium tantalite, and the like.

Each of the inorganic fine particles 32 may have a spherical shape or a non-spherical shape. The inorganic fine particles 32 may have voids therein, like porous silica. The surfaces of the inorganic fine particles 32 may be coated with a dispersant that enhances the dispersion property of the inorganic fine particles 32 in the resin material 31 as a matrix material, as long as the effect of the present disclosure can be achieved.

Generally, the inorganic fine particles 32 include primary particles 32a and secondary particles 32b each of which is formed by aggregation of a plurality of the primary particles 32a. Therefore, the state where “the inorganic fine particles 32 are uniformly dispersed in the resin material 31” means a state where the primary particles 32a and the secondary particles 32b of the inorganic fine particles 32 are substantially uniformly dispersed in the composite material 33 without being localized in a particular region of the composite material 33. It is beneficial that the particles have good dispersion property in order to prevent the light transmittance of the optical material from being degraded. For this purpose, it is beneficial that the inorganic fine particles 32 consist of only the primary particles 32a.

The particle diameter of the inorganic fine particles 32 is an essential factor in ensuring the light transmittance of the composite material 33 in which the inorganic fine particles 32 are dispersed in the resin material 31. When the particle diameter of the inorganic fine particles 32 is sufficiently smaller than the wavelength of light, the composite material 33 in which the inorganic fine particles 32 are dispersed in the resin material 31 can be regarded as a homogeneous medium without variations in the refractive index. Therefore, it is beneficial that the particle diameter of the inorganic fine particles 32 is not greater than the wavelength of visible light. Since visible light has a wavelength ranging from 400 nm to 700 nm, it is beneficial that the particle diameter of the inorganic fine particles 32 is not greater than 400 nm.

When the particle diameter of the inorganic fine particles 32 is greater than one fourth of the wavelength of light, the light transmittance of the composite material 33 may be degraded by Rayleigh scattering. Therefore, it is beneficial that the particle diameter of the inorganic fine particles 32 is not greater than 100 nm in order to achieve high light transmittance in the visible light region. However, when the particle diameter of the inorganic fine particles 32 is less than 1 nm, fluorescence may occur if the inorganic fine particles 32 are made of a material that exhibits quantum effects. This fluorescence may adversely affect the properties of optical components formed of the composite material 33.

From the viewpoints described above, the effective particle diameter of the inorganic fine particles 32 is beneficially in a range from 1 nm to 100 nm, and more beneficially in a range from 1 nm to 50 nm. In particular, it is more beneficial that the particle diameter of the inorganic fine particles 32 is not greater than 20 nm because, in this case, the effect of Rayleigh scattering is very small, and the light transmittance of the composite material 33 is particularly high.

The content of the inorganic fine particles 32 is not particularly limited, and may be appropriately adjusted depending on the optical properties such as the refractive index of the lens 1 intended. It is beneficial that the content of the inorganic fine particles 32 is 10% to 50% by weight of the total amount of the composite material 33, for example.

[4. Resin Material]

In the present disclosure, the resin material 31 as a matrix material is composed of a first resin material and a second resin material. The first resin material is composed of a compound having fluorine atom in its molecular structure, and the second resin material is composed of a compound having carbonyl group and nitrogen atom in its molecular structure.

As a typical example of the compound having fluorine atom in its molecular structure, there is a compound expressed by the following general formula (1):

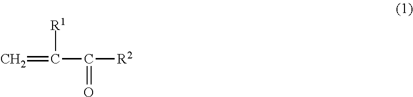

where R¹ represents an aliphatic group, and R² represents a monovalent group including fluorine atom.

Examples of the aliphatic group represented by R¹ include a straight-chain, branched-chain or cyclic alkyl group, alkenyl group, alkynyl group, and the like. These aliphatic groups each may have a substituent including oxygen atom, for example. Examples of the monovalent group including fluorine atom, which is represented by R², include: a straight-chain, branched-chain or cyclic alkyl group, alkenyl group, alkynyl group, and the like, each including fluorine atom; and a straight-chain, branched-chain or cyclic alkoxyl group and the like, each including fluorine atom. Each of these monovalent groups including fluorine atom may have a substituent including oxygen atom, for example.

As a typical example of the compound having carbonyl group and nitrogen atom in its molecular structure, there is a compound expressed by the following general formula (2):

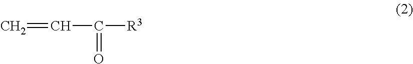

where R³ represents an amino group or a cyclic amino group.

Examples of the amino group represented by R³ include: —NH₂; —NHR⁴ (R⁴ represents a straight-chain, branched-chain or cyclic alkyl group, alkenyl group, alkynyl group, and the like which may have a substituent including oxygen atom); —NR⁵R⁶ (R⁵ and R⁶ represent, independently from each other, a straight-chain, branched-chain or cyclic alkyl group, alkenyl group, alkynyl group, and the like which may have a substituent including oxygen atom); and the like. Examples of the cyclic amino group represented by R³ include a morpholino group and the like which may have a substituent.

Regarding the resin material 31 as a matrix material of the composite material 33, if the resin material composed of the compound expressed by the general formula (1) is selected as the first resin material, more excellent anomalous dispersion property can be realized.

Meanwhile, generally, light transmittance of a composite material, which is the most important property of an optical material, is determined based on affinity between a resin material and inorganic fine particles. The fluorine compound expressed by the general formula (1) has hydrophobicity. In contrast, when the inorganic fine particles are made of metal oxide, the inorganic fine particles have hydrophilicity. Therefore, when the fluorine compound and the inorganic fine particles are used together, excellent anomalous dispersion property is realized whereas sufficient light transmittance as an optical material cannot be achieved because of the poor affinity between them.

In order to improve the affinity between the fluorine compound and the inorganic fine particles, a hydrophilic compound such as a compound having hydroxyl group may be added to the fluorine compound. Thereby, the affinity between the fluorine compound and the inorganic fine particles can be improved. However, when the fluorine compound to which the hydrophilic compound is added is used as the matrix material of the composite material, the effect of improving the anomalous dispersion property is degraded due to the hydrophilic compound. Therefore, as an additive to the fluorine compound, a compound is desired which has hydrophilicity that can improve the affinity between the fluorine compound and the inorganic fine particles, and a property that does not degrade the effect of improving the anomalous dispersion property by the fluorine compound.

The inventor has searched for such a compound that satisfies the above conditions as an additive to the fluorine compound, and found that the compound having carbonyl group and nitrogen atom in its molecular structure, which is expressed by the general formula (2), is sufficiently effective as the additive. The compound expressed by the general formula (2) has affinity with the fluorine compound because a portion bonded to N in the group represented by R³ has hydrophobicity, and has affinity with the inorganic fine particles because a portion of N—C═O has hydrophilicity. In addition, it is expected that this compound is less likely to degrade the effect of improving the anomalous dispersion property by the fluorine compound, for the reasons as follows. That is, a nitrogen atom has greater electronegativity than a carbon atom and a hydrogen atom, and therefore, has high carrier mobility. A composite material having, as a matrix material, a material including an atom of high carrier mobility shows excellent anomalous dispersion property. Therefore, it is considered that, when the compound having carbonyl group and nitrogen atom in its molecular structure is used as an additive to the fluorine compound, the resultant composite material is less likely to cause degradation of the anomalous dispersion property.

As described above, when the first resin material composed of the compound having fluorine atom in its molecular structure and the second resin material composed of the compound having carbonyl group and nitrogen atom in its molecular structure are used together, it is possible to improve affinity with the inorganic fine particles without degrading the effect of improving the anomalous dispersion property by the compound having fluorine atom in its molecular structure. That is, it is possible to obtain an optical element having excellent anomalous dispersion property and sufficient light transmittance as an optical material, by adopting the composite material obtained by combining the first resin material composed of the compound having fluorine atom in its molecular structure, the second resin material composed of the compound having carbonyl group and nitrogen atom in its molecular structure, and the inorganic fine particles.

The ratio between the first resin material and the second resin material is not particularly limited as long as an optical element having excellent anomalous dispersion property and sufficient light transmittance as an optical material can be achieved. However, it is beneficial that the ratio of first resin material/second resin material (weight ratio) is about 50/50 to 90/10.

The resin material 31 may contain additives such as an antioxidant, an ultraviolet absorbent, a mold lubricant, a conductive agent, an antistatic agent, a thermal stabilizer, and the like, as long as the effects of the optical element of the present disclosure can be achieved.

[5. Anomalous Dispersion Property]

An anomalous dispersion property APgF is a deviation between a point on a reference line of normal dispersion glass corresponding to an Abbe number vd of each material to the d-line (wavelength of 587.56 nm), and a partial dispersion ratio PgF of the material. The partial dispersion ratio PgF is defined by the following formula (b):

PgF=(ng−nF)/(nF−nC) (b)

where

ng is the refractive index of the material to the g-line (wavelength of 435.8 nm),

nF is the refractive index of the material to the F-line (wavelength of 486 nm), and

nC is the refractive index of the material to the C-line (wavelength of 656 nm).

It is beneficial that the optical element according to Embodiment 1 satisfies the following condition (a):

0<ΔPgF<0.3 (a)

where

ΔPgF is the anomalous dispersion property.

A prism coupler (MODEL 2010, manufactured by Metricon Corporation) can be used for measurement of the refractive indices, the Abbe numbers, and the APgF.

[6. Production Method]

An example of a production method of the lens 1 according to Embodiment 1 is described.

The lens 1 can be produced by preparing the composite material 33 in which the inorganic fine particles 32 are dispersed in the resin material 31 in a liquid or solution state, and molding the composite material 33. The molding can be performed by polymerization curing of the composite material 33. The method of the polymerization curing is not particularly limited, and curing by thermal polymerization or curing by energy ray polymerization may be adopted.

First, a method for forming the inorganic fine particles 32 is described. The inorganic fine particles 32 can be formed by a liquid phase method, such as a coprecipitation method, a sol-gel method, or a metal complex decomposition method, or by a vapor phase method. Alternatively, a bulk may be ground into fine particles by a grinding method using a ball mill or a bead mill to form the inorganic fine particles 32.

A method for preparing the resin material 31 as a matrix material is described. First, a first resin material composed of a compound having fluorine atom in its molecular structure and a second resin material composed of a compound having carbonyl group and nitrogen atom in its molecular structure are mixed. The mixing method is not particularly limited, and any physical method can be adopted. For example, the first resin material and the second resin material are poured into one container, and mixed. The resultant mixture is stirred by using a hot stirrer, thereby preparing the resin material 31. In order to facilitate progress of polymerization curing, it is beneficial to add a polymerization initiator during the preparation. In this case, the first resin material and the second resin material may be mixed to prepare the resin material 31, and subsequently, the resin material 31 and the polymerization initiator may be mixed.

A method for preparing the composite material 33 is described. There is no particular limitation on the method for preparing the composite material 33 from the resin material 31 as a matrix material and the inorganic fine particles 32. Any physical method may be adopted, or any chemical method may be adopted. For example, the composite material 33 can be prepared by any of the following methods (1) to (4). In the following description, a “composite resin” means a resin composed of a resin including the first resin material, and a resin including the second resin material.

(1) A composite resin or a solution in which the composite resin is dissolved is mechanically and/or physically mixed with inorganic fine particles.

(2) Monomers, oligomers, or the like as the raw materials of resins constituting a composite resin are mechanically and/or physically mixed with inorganic fine particles to obtain a mixture, and then the monomers, the oligomers, or the like as the raw materials of the resins constituting the composite resin are polymerized according to need.

(3) A composite resin or a solution in which the composite resin is dissolved is mixed with the raw material of inorganic fine particles, and then the raw material of the inorganic fine particles is reacted so as to form the inorganic fine particles in the composite resin.

(4) Monomers, oligomers, or the like as the raw materials of resins constituting a composite resin are mixed with the raw material of inorganic fine particles, followed by a step of reacting the raw material of the inorganic fine particles so as to form the inorganic fine particles, and a step of polymerizing the monomers, the oligomers, or the like as the raw materials of the resins constituting the composite resin, according to need, so as to synthesize the composite resin.

The above methods (1) and (2) are advantageous in that various pre-formed inorganic fine particles can be used and that the composite material can be prepared by using a general-purpose dispersing machine. On the other hand, the above methods (3) and (4) require chemical reactions, and therefore, usable materials are limited to some extent. However, since the raw materials are mixed at the molecular level in the methods (3) and (4), these methods are advantageous in that the dispersion property of the inorganic fine particles can be improved.

In the above methods, there is no particular limitation on the order of mixing the inorganic fine particles or the raw material of the inorganic fine particles with the composite resin or the monomers, the oligomers, or the like as the raw materials of the composite resin. An appropriate order may be determined depending on the situation.

A molding method is described. The composite material 33 is filled in a lens mold having a shape corresponding to the lens 1, and an energy ray such as a ultraviolet ray is applied to the composite material 33 to cure the composite material 33, thereby molding the lens 1.

### Embodiment 2

Hereinafter, Embodiment 2 is described with reference to the drawings.

[1. Lens]

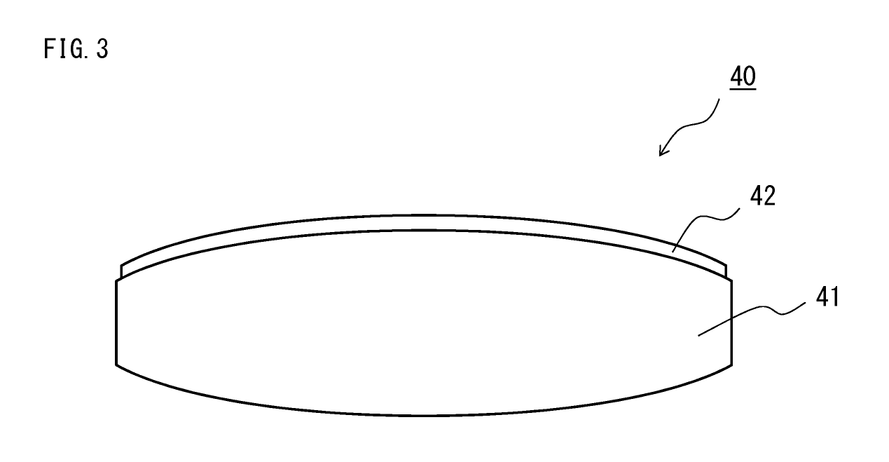

FIG. 3 is a schematic structural diagram showing a hybrid lens according to Embodiment 2. The hybrid lens 40 is composed of a first lens 41 serving as a base material, and a second lens 42. The hybrid lens 40 is an example of a hybrid optical element.

The first lens 41 is a first optical element, and an example of a glass lens. The first lens 41 is formed of a glass material, and is a bi-convex lens.

The second lens 42 is a second optical element, and an example of a resin lens. The second lens 42 is formed of the composite material 33, and the lens 1 according to Embodiment 1 is used as the second lens 42. However, the second lens 42 has a shape different from the shape shown in FIG. 1, and one of the optical surfaces thereof is concave. The second lens 42 is layered on an optical surface of the first lens 41.

[2. Production Method]

A production method of the hybrid lens 40 is described with reference to the drawings. The resin material 31 constituting the composite material 33 is a polymerized and cured product obtained by irradiating a matrix material with a ultraviolet ray.

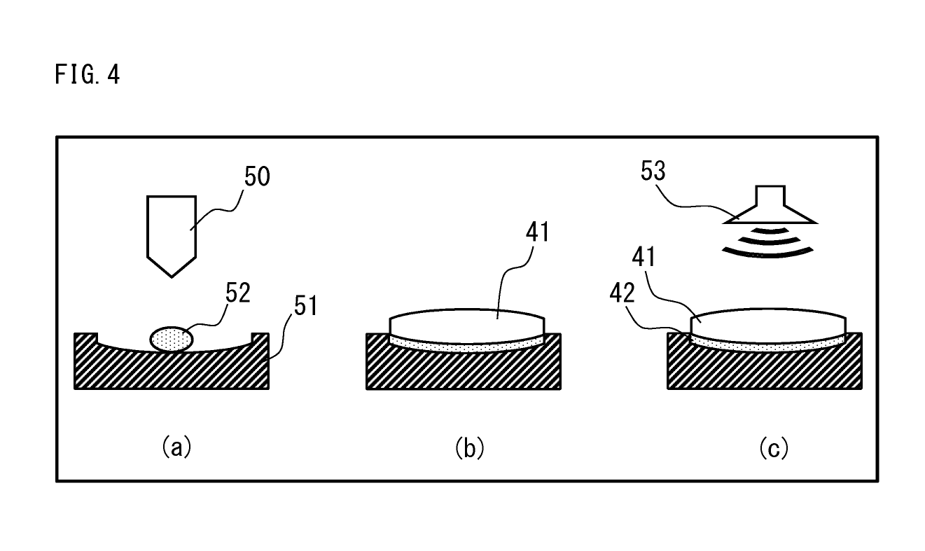

FIG. 4 is a schematic diagram explaining a production process of the hybrid lens according to Embodiment 2. First, the first lens 41 is molded. There is no particular limitation on the first lens 41 as an example of a glass lens, and the first lens 41 may be molded by using a known production method such as lens polishing, injection molding, or press molding.

As shown in FIG. 4(a), a mixture 52 (raw material of the composite material 33) in which the first resin material composed of the compound having fluorine atom in its molecular structure, the second resin material composed of the compound having carbonyl group and nitrogen atom in its molecular structure, the ultraviolet ray polymerization initiator, and the inorganic fine particles are uniformly mixed, is discharged onto a mold surface of a mold 51 by using a dispenser 50.

Next, as shown in FIG. 4(b), the first lens 41 is placed onto the mixture 52 so that the mixture 52 is pressed and expanded to a predetermined thickness.

Then, as shown in FIG. 4(c), an ultraviolet ray is applied from a light source 53 toward the top of the first lens 41 to cure the mixture 52, thereby obtaining the hybrid lens 40 as a hybrid optical element in which the second lens 42 is layered on the optical surface of the first lens 41.

### Embodiment 3

Hereinafter, Embodiment 3 is described with reference to the drawings.

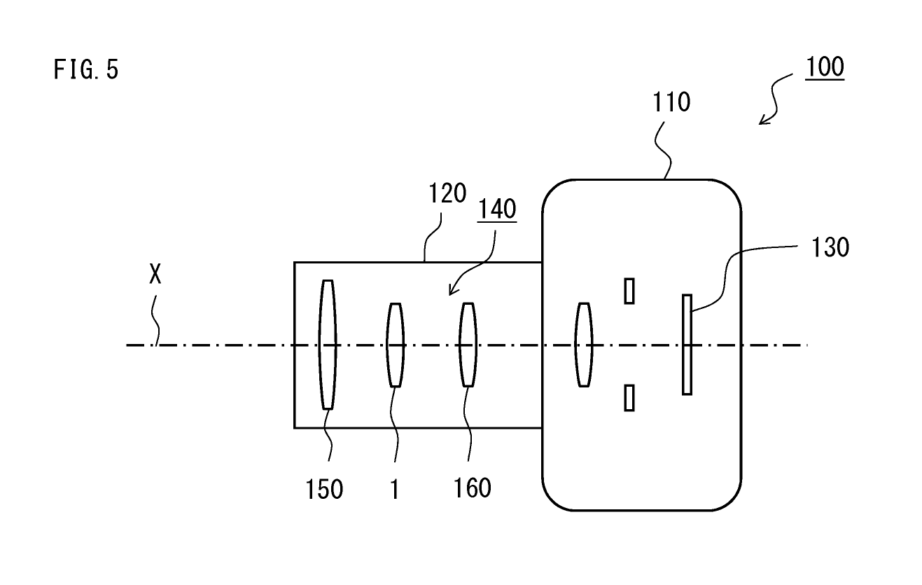

FIG. 5 is a schematic structural diagram showing an interchangeable lens and an imaging device according to Embodiment 3. A camera 100 includes a camera body 110, and an interchangeable lens 120 attached to the camera body 110. The camera 100 is an example of the imaging device. The camera body 110 has an image sensor 130.

The interchangeable lens 120 is configured to be attachable to and detachable from the camera body 110. The interchangeable lens 120 is, for example, a zoom lens. The interchangeable lens 120 has an imaging optical system 140 for focusing light flux on the image sensor 130 of the camera body 110. The imaging optical system 140 is composed of the lens 1 according to Embodiment 1, and refractive lenses 150 and 160.

In another embodiment of the interchangeable lens 120 and the camera 100, the hybrid lens 40 according to Embodiment 2 may be used instead of the lens 1 according to Embodiment 1.

In another embodiment of the camera 100, a camera may have a camera body section and a lens section configured to be inseparable from the camera body section, and the lens section may include the lens 1 according to Embodiment 1 or the hybrid lens 40 according to Embodiment 2.

As described above, Embodiments 1 to 3 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

Hereinafter, examples according to the present embodiment and comparative examples are described. However, the present disclosure is not limited to these examples.

The results of the examples and the comparative examples are shown in Table 1 described later. In Table 1, the refractive index is a value measured at a wavelength of 587.56 nm, the anomalous dispersion property is a value of ΔPgF, and the transmittance is a value measured at a wavelength of 550 nm. The refractive index was measured by using a prism coupler (MODEL 2010, manufactured by Metricon Corporation), and the transmittance was measured by using a spectrophotometer (UV3150, manufactured by Shimadzu Corporation).

### Example 1

A composite material containing: 55% by weight of a compound having fluorine atom in its molecular structure, which is expressed by the following chemical formula (3); 20% by weight of a compound having carbonyl group and nitrogen atom in its molecular structure, which is expressed by the following chemical formula (4); 3% by weight of a polymerization initiator (Irgacure 184, manufactured by BASF Societas Europaea, 1-Hydroxycyclohexyl phenyl ketone, weight-average molecular weight of 204); 2% by weight of a dispersant (Nopco Sperse 44-C, manufactured by Sanyo Chemical Industries, Ltd.); and 20% by weight of TiO₂ fine particles (average particle diameter of 20 nm) was irradiated with a ultraviolet ray (80 mW/cm²·90 sec) by using a UV irradiation apparatus (SP-9, manufactured by USHIO INC.) to cure the composite material, and thus a sample of a 0.2 mm-thick optical element for evaluation of optical properties was fabricated. Also in the following Examples 2 to 4 and Comparative Example 1, samples were fabricated in the same manner as described above.

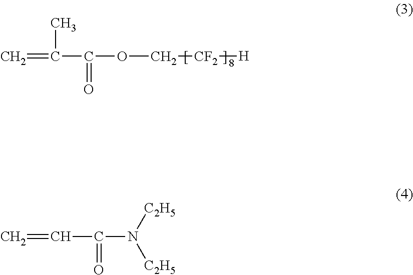

As shown in Table 1, the sample of Example 1 showed small positive anomalous dispersion property, which satisfies the condition (a), and had the transmittance exceeding 95%. Therefore, it is understood that the sample of Example 1 is valuable as an optical element.

### Example 2

A sample of Example 2 was fabricated in the same manner as Example 1 except that a compound having carbonyl group and nitrogen atom in its molecular structure, which is expressed by the following chemical formula (5), was used instead of the compound having carbonyl group and nitrogen atom in its molecular structure, which is expressed by the chemical formula (4) of Example 1.

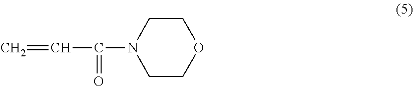

As shown in Table 1, the sample of Example 2 showed small positive anomalous dispersion property, which satisfies the condition (a), and had the transmittance exceeding 95%. Therefore, it is understood that the sample of Example 2 is valuable as an optical element.

### Example 3

A sample of Example 3 was fabricated in the same manner as Example 1 except that a compound having carbonyl group and nitrogen atom in its molecular structure, which is expressed by the following chemical formula (6), was used instead of the compound having carbonyl group and nitrogen atom in its molecular structure, which is expressed by the chemical formula (4) of Example 1.

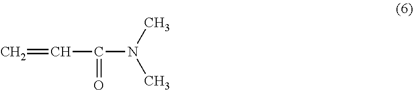

As shown in Table 1, the sample of Example 3 showed small positive anomalous dispersion property, which satisfies the condition (a), and had the transmittance exceeding 95%. Therefore, it is understood that the sample of Example 3 is valuable as an optical element.

### Example 4

A composite material containing: 40% by weight of a compound having fluorine atom in its molecular structure, which is expressed by the chemical formula (3); 14.5% by weight of a compound having carbonyl group and nitrogen atom in its molecular structure, which is expressed by the chemical formula (4); 1.5% by weight of a polymerization initiator (Irgacure 184, manufactured by BASF Societas Europaea, 1-Hydroxycyclohexyl phenyl ketone, weight-average molecular weight of 204); 4% by weight of a dispersant (Nopco Sperse 44-C, manufactured by Sanyo Chemical Industries, Ltd.); and 40% by weight of TiO₂ fine particles (average particle diameter of 20 nm), was irradiated with a ultraviolet ray (80 mW/cm²·90 sec) by using a UV irradiation apparatus (SP-9, manufactured by USHIO INC.) to cure the composite material, and thus a sample of a 0.2 mm-thick optical element for evaluation of optical properties was fabricated.

As shown in Table 1, the sample of Example 4 showed small positive anomalous dispersion property, which satisfies the condition (a), and had the transmittance exceeding 90%. Therefore, it is understood that the sample of Example 4 is valuable as an optical element.

### Comparative Example 1

A sample of Comparative Example 1 was fabricated in the same manner as Example 1 except that a hydrophilic aliphatic compound having hydroxyl group in its molecular structure, which is expressed by the following chemical formula (7), was used instead of the compound having carbonyl group and nitrogen atom in its molecular structure, which is expressed by the chemical formula (4) of Example 1.

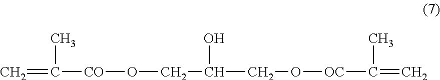

As shown in Table 1, although the sample of Comparative Example 1 had the transmittance exceeding 90%, the anomalous dispersion property thereof was degraded as compared with any of the samples of Examples 1 to 3 which were fabricated under the same condition as Comparative Example 1 except that not the hydrophilic compound but the compound having carbonyl group and nitrogen atom in its molecular structure was used. The reason is thought to be as follows. In Comparative Example 1, not the compound having carbonyl group and nitrogen atom in its molecular structure but the hydrophilic compound was added to the compound having fluorine atom in its molecular structure, the effect of improving the anomalous dispersion property by the fluorine compound was degraded.

TABLE 1

| | | | | Inorganic fine particles | | Optical property of sample | | |
|---|---|---|---|---|---|---|---|---|
| | | Compound A | Compound B | | Concentration | | Anomalous | |
| | | Chemical | Chemical | | (% by | Refractive | dispersion | Transmittance |
| | | formula No | formula No | Kinds | weight) | index | property | (%) |
| Ex. | 1 | (3) | (4) | TiO₂ | 20 | 1.51248 | +0.080 | 95.8 |
| | 2 | (3) | (5) | TiO₂ | 20 | 1.51534 | +0.077 | 96.1 |
| | 3 | (3) | (6) | TiO₂ | 20 | 1.51491 | +0.078 | 95.5 |
| | 4 | (3) | (4) | TiO₂ | 40 | 1.56423 | +0.122 | 91.5 |
| Com. Ex. | 1 | (3) | (7) | TiO₂ | 20 | 1.51558 | +0.050 | 96.0 |

Compound A: Compound having fluorine atom in its molecular structure
Compound B: Compound having carbonyl group and nitrogen atom in its molecular structure (Ex. 1-4) or Hydrophilic compound (Com. Ex. 1)

The present disclosure is suitably used for imaging devices, interchangeable lenses of image sensors, DVD optical systems, and the like.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. An optical element formed of a composite material comprising a resin material and inorganic fine particles dispersed in the resin material, wherein
the resin material is composed of a first resin material comprising a compound having fluorine atom in its molecular structure, and a second resin material comprising a compound having carbonyl group and nitrogen atom in its molecular structure.

2. The optical element as claimed in claim 1, wherein the inorganic fine particles are made of a metal oxide having a particle diameter ranging from 1 nm to 100 nm.

3. The optical element as claimed in claim 1, wherein the following condition (a) is satisfied:
0<ΔPgF<0.3 (a)
where
ΔPgF is anomalous dispersion property.

4. A hybrid optical element comprising a first optical element serving as a base material, and a second optical element layered on an optical surface of the first optical element, wherein
the second optical element is the optical element as claimed in claim 1.

5. An interchangeable lens being attachable to and detachable from an imaging device, and comprising the optical element as claimed in claim 1.

6. An interchangeable lens being attachable to and detachable from an imaging device, and comprising the hybrid optical element as claimed in claim 4.

7. An imaging device comprising the optical element as claimed in claim 1.

8. An imaging device comprising the hybrid optical element as claimed in claim 4.
